(19) United States
(12) Patent Application Publication
(10) Pub. No.: US 2004/0206458 A1
(43) Pub. Date: Oct. 21, 2004

(54) Sticking roller

(75) Inventors: Takuya Hayasaka, Tokyo (JP); Kenji Kobayashi, Tokyo (JP); Nobuyoshi Oumiya, Tokyo (JP); Katsuhide Tsukamoto, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 10/820,697

(22) Filed: Apr. 9, 2004

(30) Foreign Application Priority Data
Apr. 16, 2003 (JP) 2003-111377

(51) Int. Cl. B32B 31/00

(52) U.S. Cl. 156/391; 156/539

(57) ABSTRACT

This invention relates to a sticking roller for sticking a label on an information recording board having a nearly doughnut shape in a plan view. The roller comprises a roller body and an elastic member fitted on the outer circumference of the roller body. The roller body has a fitting part for fitting the elastic member on the outer circumference of the roller body, and the fitting part has stepped portions along the inner and outer circumferential edges of the elastic member. The stepped portions regulate a deformation or shift of the elastic member in its surface direction when applying a sticking force on the label via the surface of the elastic member.

### BACKGROUND OF THE INVENTION

1. Field of the Invention

This invention relates to a sticking roller, particularly to a roller with which a label can be precisely stuck to an information recording medium as an adherend such as an optical disc immediately after pre-cutting the label.

2. Description of the Related Art

Sticking a film-shaped sheet on the surface of an information recording board, such as a semiconductor wafer, has been commonly practiced. In a sticking operation, for example, a method of pressing force adjustment of a sticking roller is employed to prevent air bubbles enclosing between an adherend and a sheet. This method is described in a patent document 1: Japanese Patent Application Publication No. 2003-19755. According to the patent document 1, the pressing force of a sticking roller is adjusted so as to be strongest at the center of the adherend and getting weaker as the contact of the roller recedes from the center. This adjusting method of the pressing force, however, requires a specific means, which raises an issue of complicated structure.

An optical disc is known to have a high capacity for recording and reproducing a large volume of information. A disc has a recording layer on one side, on which a light-transmitting film or label is stuck to protect the recording layer. Film sticking process conventionally employs a rolled-up band-type material sheet, which comprises a base sheet made of consecutively extending peeling sheet or the like and protection labels stuck on one surface of the base sheet at established intervals. The material sheet is held by a feeding means arranged upstream relative to a label sticking means. In a process of feeding out the band-type material sheet, the feeding direction of the material sheet is reversed sharply to peel a protection label from the base sheet and stick the peeled label to an optical disc.

A label-sticking apparatus described above, however, has such a structure as protection labels, which are formed into the shape of the optical disc beforehand, are fed out one after another from the rolled-up state together with a base sheet. Consequently a pressed mark is usually formed on the protection label and this pressed mark causes quality deterioration and sticking failure of protection labels. Specifically, the protection labels are glued to the base sheet via adhesive and are rolled up together with the base sheet, and each protection label on different turn of rolling along the radial direction of the roll may not be overlapped in a precisely aligned position across the layers. As a result, elastic deformation of adhesive and the edges of the protection labels overlapped each other generate pressed marks (stepped marks) or pressed flaws on the surface of the protection label due to rolling pressure, thus its surface precision degrades. When a protection label with such a pressed mark or flaw is stuck to an optical disc, the recording or reproducing capacity of the disc deteriorates heavily. Further, manufacturing process and sticking process of protection labels have to be independent and executed separately, which leads to a problem of decreased manufacturing efficiency of optical discs.

Hereupon, the applicant invented a sticking apparatus that effectively avoids a conventional problem of sticking failures due to a roll curl (Japanese Open-Laid Application No. 2002-298535), in such a manner that labels are pre-cut in the process of feeding a band-type material sheet, and each pre-cut label is stuck to a disc-shaped information recording board immediately after pre-cutting.

This method of pre-cutting labels, however, requires the pressing blade of a rotary die or the like, which inevitably causes a deformation of an adhesive around a cutting face. Therefore there is a problem that it tends to introduce fine air bubbles between the label and an optical disk, along the inner and outer circumferential edges of the label when it is stuck.

To solve this problem, the applicant tried to provide, for example, a sticking roller 100 as shown in FIG. 6(A), which comprises a rod-shaped roller body 101 and an elastic member 102 such as rubber, which has roughly an initial shape of doughnut in plan view and approximately corresponds to the plan shape of the optical disc, and is wound around the outer circumference of the roller body. The constitution of this sticking roller 100, however, also did not solve the problem of the formation of fine air bubbles between the label and the optical disc along the inner and outer circumferences of the label stuck.

The earnest study by the inventor revealed that a reaction force against a press force of label sticking shown by an arrow in FIG. 6(B), deforms the outer circumferential edge 102A and the inner circumferential edge 102B of the elastic member 102 outward in the surface direction of the elastic member, and this deformation generates a relatively poorer sticking force in the nearby area along the outer circumferential edge 102A and the inner circumferential edge 102B compared to other areas.

### SUMMARY OF THE INVENTION

The purpose of this invention is to provide a sticking roller, which prevents enclosure of fine air bubbles along the circumference of a pre-cut label when it is stuck to a disc-shaped information recording board immediately after pre-cutting.

To achieve the above purpose, the present invention provides such constitution as the sticking roller for sticking a label to a predetermined adherend comprises a shaft-shaped roller body, and an elastic member that is fitted on the outer circumference of the roller body and contacts with a non-adhesive face of the label, wherein the roller body is provided with a fitting part to fit the elastic member on the outer circumferential surface, and the elastic member is fit in the fitting part in such a manner that the top surface of the elastic member is positioned above the outer circumferential surface of the roller body. According to the above constitution of a sticking roller, the depth of the fitting part prevents the elastic member from deforming in its surface direction while allowing the compression deformation in stead, thus preventing the tendency that the adjacent areas along the elastic member edges have relatively poorer adhesive capability than the other areas. Further, since the above constitution allows sticking the label while crushing the adhesive definitely, enclosure of air bubbles, which are generated by the deformation of the adhesive near the cutting face of a rotary die, can be prevented.

According to the present invention, the adherend is an information recording board having an nearly doughnut shape in a plan view;

the elastic member is formed to be an nearly doughnut shape approximately corresponding to the plan shape of the information recording board;

the fitting part has stepped portions along the inner and outer circumferential edges of the elastic member; and the stepped portions prevent the elastic member from deforming or shifting in its surface direction when a sticking force is applied on the label via the surface of the elastic member. With these arrangements, the purpose of the present invention is achieved successfully.

In the present specification, ‘label’ represents a protection label stuck on a recording layer of an object, such as a disc, for a protective purpose, as well as a label or sheet for forming information pits thereon using an energy line hardening.

### BRIEF DESCRIPTION OF THE DRAWINGS

FIG. 1 is a schematic front view of a sticking apparatus related to the embodiment of the invention;

FIG. 2 is a fragmentary perspective view of the sticking apparatus whose constitution shown in FIG. 1 is changed for the purpose of illustration;

FIG. 3 is an enlarged front view of a sticking means;

FIG. 4 is a schematic top view of a stage holding recording boards;

FIG. 5(A) is a front view of the sticking roller;

FIG. 5(B) is a sectional view of the sticking roller;

FIG. 5(C) is a partial enlargement of FIG. 5(B);

FIG. 6(A) is a sectional view of a sticking roller without the fitting part; and

FIG. 6(B) is a partial enlargement of FIG. 6(A).

### DETAILED DESCRIPTION OF THE PREFERRED EMBODIMENT

Hereinafter, preferred embodiments of this invention are described referring to the figures.

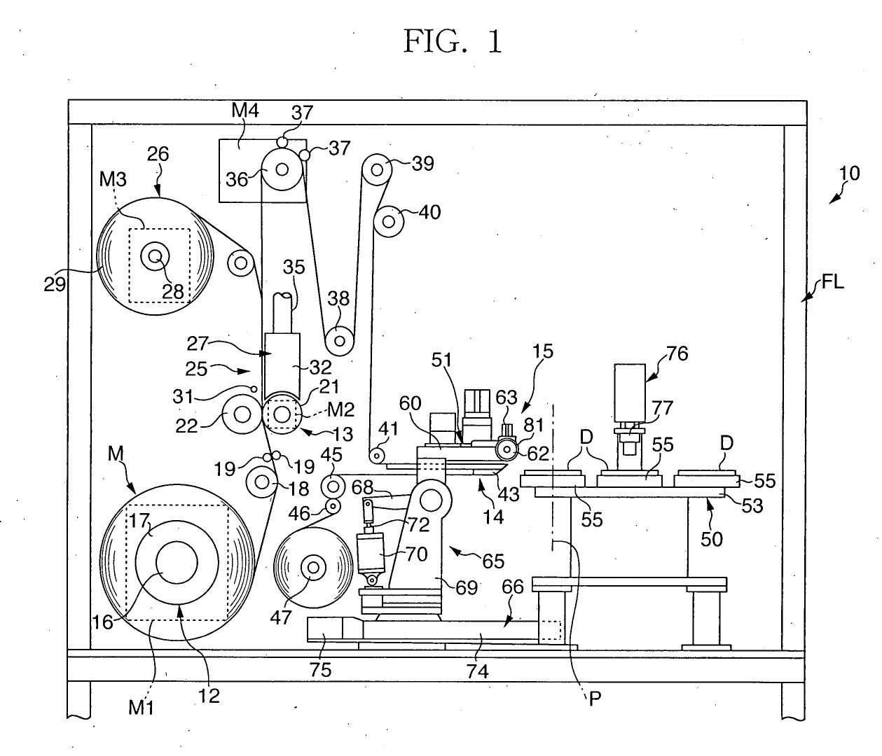

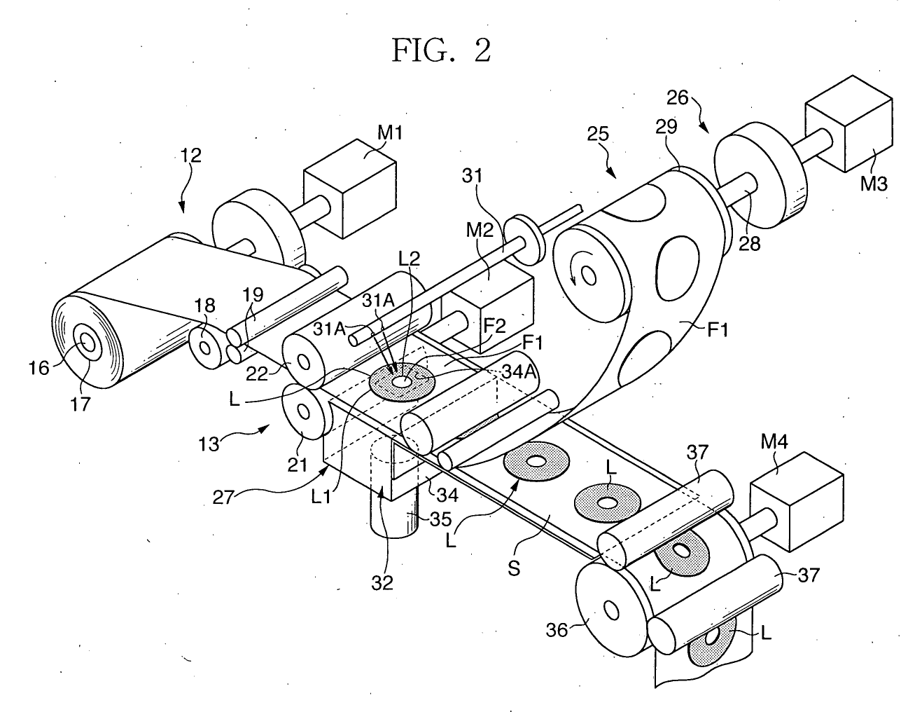

FIG. 1 shows a schematic structure diagram of the sticking apparatus which is equipped with a sticking roller according to the present invention. FIG. 2 shows a fragmentary schematic perspective view in which the arrangement of the components shown in FIG. 1 is changed for the purpose of description. As shown in figures the sticking apparatus 10 is composed so that a frame FL surrounding the outer shape of the apparatus can contain the whole. In the frame FL, a sticking apparatus 10 comprises a feeding means 12 ready to feed out a rolled- up band-shaped material sheet M, a pre-cutting means 13 for forming predetermined incisions on the band-shaped material sheet M fed out from the feeding means 12, a peeling means 14 for peeling off protection labels L (see FIG. 2) formed by the pre-cutting means 13 from a base sheet S, and a label sticking means 15 for sticking the peeled-off protection label L to an adherend or an optical disc D (recording board).

A band-shaped material sheet M consists of a base sheet S that works as a peeling sheet, and a film F that is for forming protection labels and is layered on one surface of the base sheet S via an adhesive. The band-type material sheet M is rolled up on the feeding means 12 and ready to be sequentially fed out therefrom.

The feeding means 12 comprises a motor M1 and a rotating shaft 16 connected to it, and the rolling core 17 of the band-type material sheet M is to be inserted on the outer circumference of the rotating shaft 16. The band-type material sheet M fed out from the feeding means 12 is sent to the pre-cutting means 13 via a guide roller 18 and a pair of antistatic bars 19, which are arranged opposite to each other so as to allow the band-type material sheet M to pass through between the bars 19 and remove the static electricity from the material sheet M if it is charged.

The pre-cutting means 13 comprises a die-bearing roll 21 rotatable by a motor M2 and a die-cut roll 22, which is placed opposite to the die-bearing roll 21 to work with it to pinch the band-type material sheet M. The die cut roll 22 has a blade (not shown) formed on the outer circumference thereof. When the die-cut roll 22 rotates, the blade forms an outer incision L1 and an inner incision L2 on the surface of the band-type material sheet M in such a way that both incisions forms concentric circles that correspond to the doughnut-like plan surface of the recording board D. The film area between the outer incision L1 and the inner incision L2 forms a protection label L, and the area outside of the outer circumference of the protection label L is to be an outer film area F1, and the area formed in the center of the protection label and surrounded by the inner incision L2 is to be an inner film area F2. The outer incision L1 is formed only on the film F, while the inner incision L2 is formed on both the film F and the base sheet S. As a result, the nearly doughnut-shaped protection label L remains on the base sheet S to be sent downstream together with the base sheet S, while the outer film area F1 and the inner film area F2 can be retrieved using a retrieving means 25.

The retrieving means 25 comprises the first retriever 26 for retrieving the outer film area F1 and the second retriever 27 for retrieving the inner film area F2. The first retriever 26 comprises a motor M3 and a take-up drum 29 supported on an output shaft 28 of a motor M3, the revolution of which sequentially retrieves the outer film area F1 as a scrap.

The second retriever 27 is arranged near a die-cut roll 22, and comprises a tube 31, which is a blowing means extended in the width direction of the band-type material sheet M, and a suction means 32 located opposite to the tube 31 across the band-type material sheet M. Two nozzles 31A are formed on the tube 31 in the axial direction thereof, and air is jetted out from the nozzles onto the inner film area F2. Meanwhile, in FIG. 2, the suction means 32 comprises a box 34 placed under the band-type material sheet M and a suction pipe 35 for decompressing the box 34. On the upper face of the box 34, a suction hole 34A is opened slightly larger than the inner film area F2 so as to retrieve the inner film area in the box 34 through the suction hole 34A. Thus, the band-type material sheet M with the protection labels L left on the base sheet S is sequentially sent toward the peeling means 14 via a drive roller 36 arranged upstream relative to the peeling means 14.

The drive roller 36 is fixed on the output shaft of a motor M4, and two pinch rollers 37, 37 are arranged separately on the outer periphery of a motor M4. The base sheet S and the protection labels L sent out by the drive roller 36 are further transferred to the peeling means 14 via a dancer roller 38 working as a slacking mechanism and guide rollers 39, 40, 41 arranged downstream relative to the dancer roller.

The peeling means 14 comprises a peel plate 43 fixed to the frame FL in this embodiment. The base sheet S and the protection labels L are wound at the end of the peel plate 43 in such a way that the transfer direction of the base sheet and labels are sharply reversed at the front extremity of the peel plate 43 (shown at the right end in the middle of FIG. 1), where each protection label L can be peeled off forward almost in the horizontal plane (shown at the center right in FIG. 1). The leading end of the base sheet S is fixed to the rolling core of a take-up drum 47 attached to a motor (not shown) via guide rollers 45, 46. Thus the peeled protection label L is stuck on the recording layer surface of the recording board D by the label sticking means 15.

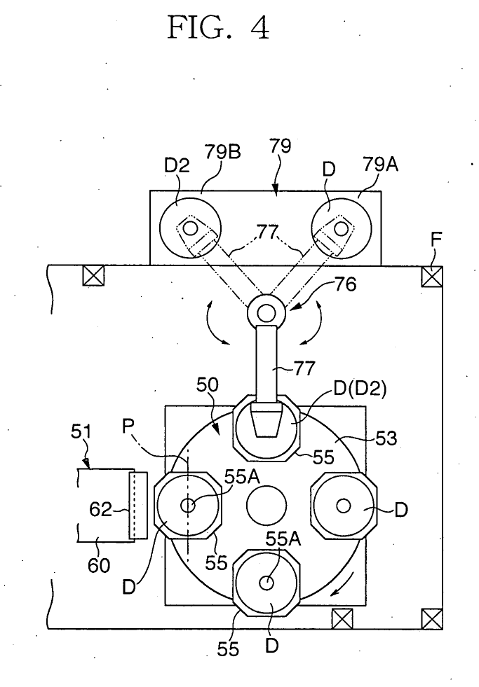

The label sticking means 15 comprises a stage 50 supporting the recording boards D and a label holder 51 that is movable relatively to the recording board D positioned in a sticking center position P (see FIG. 1). As shown in FIG. 4, the stage 50 comprises a rotating plate 53 that is rotatable in a plane, and holding tables 55 which are arranged on the rotating plate 53 at an approximately 90 degrees interval along its circumference and ready to load the recording boards D on the upper face side. At the center of each holding table 55, a centering hole 55A is formed (see FIG. 4), and a chuck (not shown) is arranged to move through the hole 55A in up-and-down direction to center the recording board D on the holding table 55.

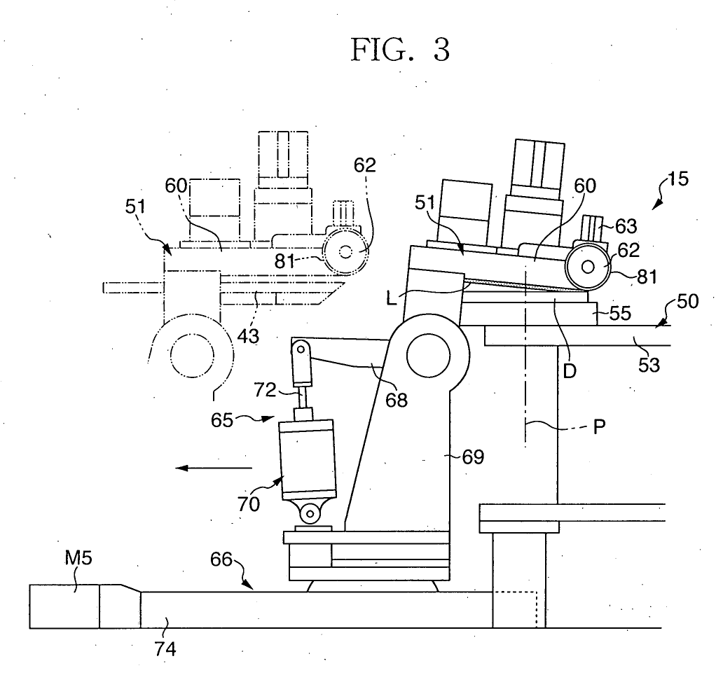

As shown in FIG. 3, the label holder 51 comprises a suction member 60 that is arranged to suck the upper surface of the protection label L that is peeled off by the peel plate 43, and a sticking roller 62 that is arranged on the side of one end of the suction member 60, and on the side of the recording board D located in the sticking center position P according to the present embodiment, wherein the sticking roller being provided with a cylinder 63 enabling the predetermined pressing force setting. The label holder 51 is supported by a position changing means 65 that can change the position of the suction member 60 between an almost level position and an inclined position, and the position changing means 65 can move horizontally, in right and left direction as indicated in FIG. 3, via a moving means 66.

A number of vacuum holes (not shown) are formed on the lower surface of the suction member 60 of the label holder 51, which is movable to the right as indicated in FIG. 3 at a corresponding speed to a transfer speed of the protection label L. A centering hole (not shown) is also formed on the lower surface of the suction member 60, and a chuck moving up and down through the hole makes it possible to center the protection label L that is sucked and held on the lower surface of the suction member 60. Here, the right end of the label L is pre-arranged to the position to reach a lower part of the outer circumference of the sticking roller 62 as shown in the figure. When the label holder 51 moves to the above of the recording board D located in the sticking center P by means of the moving means 66, the position of the label holder 51 is shifted to the inclined position so that the side of sticking roller 62 becomes lower by means of the position changing means 65.

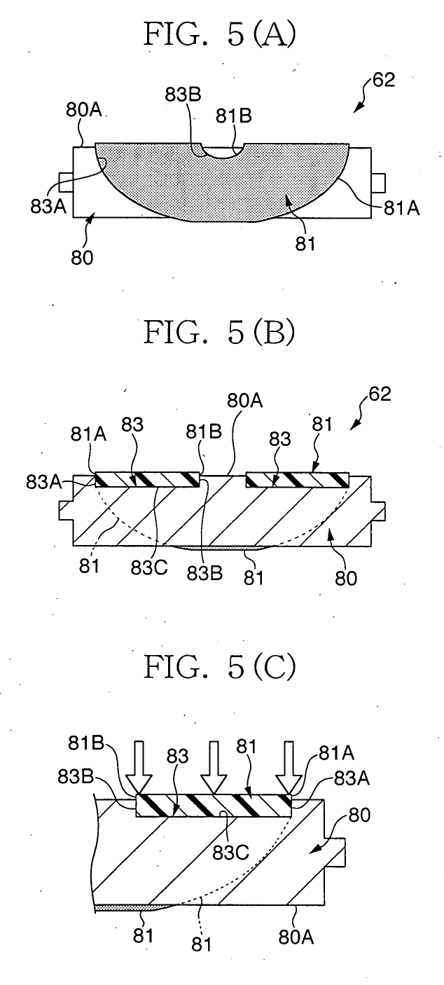

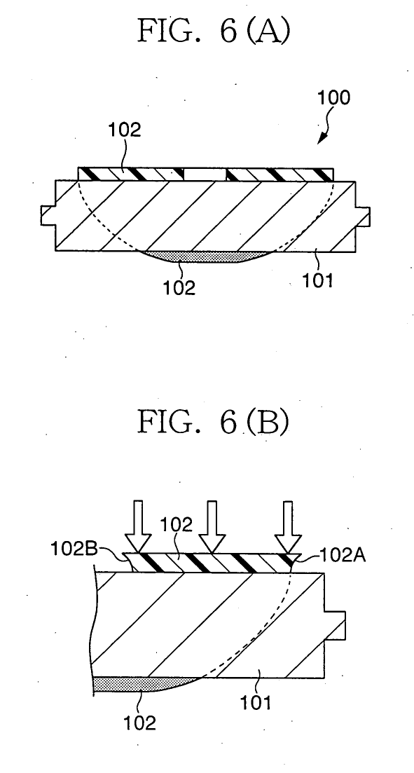

As shown in FIG. 5(A) and 5(B), the sticking roller 62 comprises a nearly round-shaped roller body 80, and an elastic member 81 being wound along the outer circumference of the roller body 80 and contacting with a non-adhesive surface of the protection label L.

On the outer circumferential surface of the roller body 80, a fitting part 83 for fitting the elastic member 81 is formed. The fitting part 83 comprises stepped portions 83A, 83B, which run along the outer circumferential edge 81A and the inner circumferential edge 81B of the elastic member 81 when it is wound around the roller body 80, and a fitting face 83C, which is formed between the stepped portions 83A, 83B by recessing the outer circumferential surface of the roller body 80 toward the axial center direction. The depth of the stepped portions 83A and 83B is made shallower than the thickness of the elastic member 81, so that the top surface of the elastic member comes in contact with the label L.

The elastic member 81 is made of rubber, urethane or the like, and retains an doughnut-like plan shape before being wound around the roller body 80 which corresponds to the recording board D shape. In this embodiment, the thickness of the elastic member 81 is approximately 3 mm, while the height of the stepped portions 83A, 83B, namely the depth of fitting part 83 is approximately 2.7 mm. Accordingly, the elastic member 81 is projected outward by approximately 0.3 mm against the outer circumferential surface 80A of the roller body 80 excepting the fitting part 83. It is desirable for the elastic member 81 to be 0.5 to 10 mm thick, specifically desirable to be 2 to 5 mm. The projected amount of the elastic member 81 above the outer circumferential surface 80A of the roller body 80 is desirably to be 0.1 to 1 mm, specifically to be 0.1 to 0.5 mm, depending on the elastic modulus of the elastic member.

The position changing means 65 comprises an almost L-shaped bracket 68 placed on both side-ends of the suction member 60 in the perpendicular direction to the page surface in FIG. 3, a bearing 69 supporting the bracket 68 in a rotatable manner, and a cylinder 70 connected to the front end of the bracket 68. The cylinder 70 has a rod 72, which can reciprocate vertically and keeps the suction surface of the suction member 60 almost level when the rod is at the backward stroke end while changes the position of the suction member 60 to the inclined position when the rod goes up in a forward stroke.

The moving means 66 comprises a motor M5 that can rotate both directions, and a feeding unit 74 consisting of, e.g., a feeding screw fixed to the output shaft of the motor M5. A lower part of the bearing 69 is engaged with the feeding unit 74 via a screw mechanism to enable the position changing means 65 and the label holder 51 to move horizontally in right and left direction in FIG. 3.

Near the stage 50, as shown in FIG. 4, a robot 76 is set up for charging and discharging the recording boards D. Arms 77 of the robot 76 are arranged rotatable in a nearly horizontal plane and movable vertically. The lower end surface of the arm 77 is a suction surface, which can swing between a stocker 79 provided on the outside of the frame FL and the stage 50. The stocker 79 consists of the first stock section 79A in which recording boards D with no protection labels L thereon are piled up, while the second stock section 79B in which recording boards D2 with the protection labels L thereon are piled up one after another. Each stock section 79A, 79B includes a vertically movable carrier base (not illustrated), on which the recording boards D or D2 are piled up.

Next, the overall operation of the sticking apparatus 10 in this embodiment is described.

Firstly, the initial setup is implemented as follows. A certain amount of the rolled band-type material sheet M is pulled out, and the base sheet S and the film F are manually separated from each other at a certain point on the way, then the leading end of the base sheet S is fixed to the take-up drum 47, while the leading end of the film F is fixed to the take-up drum 29 of the retriever 26 included in the retrieving means 25.

Then, the predetermined power source is actuated to drive the motor M4 of the drive roller 36, which feeds out the band-type material sheet M. At this time, the motor M1 of the feeding means 12 is provided with a certain feed resistance, therefore the band-type material sheet M is fed out keeping a certain tensile force suitably enough to maintain the flat shape of the protection labels L. When the band-type material sheet M that is fed out passes through the pre-cutting means 13, the outer incisions L1 and the inner incisions L2 are formed on the band-type material sheet M corresponding to the shape of the recording boards D. Air from nozzles 31A of the tube member 31 is jetted onto each inner film area F2 inside of the inner incision L2, that is sucked into the suction hole 34A of the box 34, thus leaving a punched hole in the center of a label. Almost coincidently, the outer film area F1 is wound up on the take-up drum 29, which leaves only the protection labels L on the base sheet S.

Protection labels L formed in this way are sent to the extreme end of peel plate 43 together with the base sheet S and peeled off, sucked and held on the suction member 60 of the label holder 51. More specifically, a sensor (not illustrated) detects the timing when the feed direction end (leading end) of the protection label L comes almost under the axis of the sticking roller 62, and at the same time the moving means 66 moves the label holder 51 to the right direction in FIG. 1 at the same speed with feeding speed of the protection label L, and each protection label L is sequentially peeled from the front end of the peel plate 43 and sucked on the suction surface of the suction member 60 to be held thereon. In parallel to the above operation, recording boards D are placed on respective holding tables 55 in the centered position on the stage 50 of the label sticking means 15, one of which comes to the sticking center position P and is held in a state of stand-by.

Afterward, when the label holder 51 reaches the position shown by a solid line in FIG. 3, the position changing means 65 makes the label holder 51 incline so that the sticking roller 62 is lowered. At this time, the right end of the protection label L coincides with a predetermined sticking start point of the recording board D, moreover the outer circumferential edge of the elastic member 81 has been also preset to coincide with the sticking start point simultaneously. Then, as the label holder 51 moves to the left direction indicated in FIG. 3, the sticking roller 62 rolls over the recording board D while keeping apply a predetermined pressing force by the cylinder 63, thus the protection label L on the suction member 60 is transferred to stick to the recording board D. At this time, although the elastic member 81 receives a pressing force (reaction) in an arrow direction as shown in FIG. 5(C), a deformation of the elastic member 81 caused by the reaction is absorbed by its compressive deformation with the help of stepped portions 83A, 83B, thereby a lateral, outward deformation of the elastic member along its surface that used to exist conventionally is prevented effectively. This makes it possible to act the predetermined pressing force securely on the vicinity-of the edge of the label L. Meanwhile, as the label holder 51 is in the inclined position, the air between the protection label L and the recording board D is pushed away in the direction of the label holder 51 movement, thus the enclosing fine air bubbles between both sticking surfaces, particularly along the inner and outer circumferential edges of the label L can be avoided. That is, fine air bubbles on the sticking surface of the label due to the deformation of the adhesive on the cutting face by the rotary die, can be prevented by sticking the label through steadily crushing the adhesive.

When the protection label L is stuck on the recording board D located in the sticking center position P on the stage 50, as described above, the stage 50 rotates clockwise approximately 90 degrees to set another recording board D in the sticking center position P awaiting the process. The recording board D2 with the label D thereon is transferred by the robot 76 to the second stock section 79B of the stocker 79, and piled up one after another. Then the robot 76 picks up one of the recording boards D with no label from the first stock section 79A and transfers to the holding tables 55.

Hereafter the same processes are repeatedly executed to stick the protection labels L on the recording boards D sequentially.

According to this embodiment, although the pressing force is applied upon the elastic member 81 when sticking labels L on the recording board D, the stepped portions 83A, 83B of the fitting part 83 formed on the roller body 80 regulates the shift of the elastic member 81 in its surface direction, thus the elastic member 81 has only the compression deformation and the pressing force acts uniformly on the label L. Therefore an effect of eliminating the fine air bubbles enclosure is obtained because it is possible to stick the label on the recording board through steadily crushing the adhesive to get rid of the air bubbles due to the deformation of the adhesive near the cutting face formed by the rotary die.

The above description discloses the optimum constitution and method to implement the present invention but it should be understood that this description is not intended to limit the invention. That is, the specific embodiments are described and illustrated especially, but the present invention allows various modifications of the embodiment based on the requirement of those skilled in the art, e.g., shapes, positions, arrangement, or the like related to the invention under the conditions that the changes are within the technical concept and the scope of the present invention.

For example, the height or the amount of projection of the elastic member 81 in respect to the outer circumferential surface 80A of the roller body 80 excepting the fitting part 83, will not limit the present invention, but may be modified according to an elastic modulus of an employed elastic member.

A case of sticking the label L on the adherend, such as the recording board of an optical disc, is described in the above embodiment. It will also be appreciated that the art disclosed in the embodiment herein can be applied to other cases, such as a case where a label or a sheet is stuck on a different object other than the optical disk or the like.

As described above, according to the present invention the deformation of the elastic member in its surface direction is regulated due to the depth of the fitting part of the elastic member and the compressive deformation is generated instead, hence the relative shortage of the sticking force is avoided in the neighboring area along the elastic member edge compared with the other area, which results in eliminating the enclosure of fine air bubbles. Thus it is possible to provide a sticking roller presenting unprecedented excellent performance.

What is claimed is:

1. A sticking roller for sticking a label to an adherend, comprising a shaft-shaped roller body, and an elastic member which is fitted on the outer circumference of said roller body and contacts with a non-adhesive face of said label,
said roller body having a fitting part for fitting the elastic member on the outer circumferential surface,
said elastic member being fitted in said fitting part, wherein the top surface of said elastic member is arranged above the outer circumferential surface of said roller body.

2. A sticking roller according to claim 1,
said adherend being an information recording board which has a nearly doughnut shape in a plan view,
said elastic member being formed into a nearly doughnut shape corresponding to the plan shape of said information recording board,
said fitting part having stepped portions along an inner circumferential edge and an outer circumferential edge of said elastic member, wherein said stepped portions regulate a deformation or shift of said elastic member in its surface direction when a sticking force is applied to the label on the surface of said elastic member.
